(19) United States
(12) Patent Application Publication
(10) Pub. No.: US 2022/0204720 A1
(43) Pub. Date: Jun. 30, 2022

(54) METHOD FOR DECOLORIZATION OF POLYESTER FABRIC

(71) Applicant: INDUSTRIAL TECHNOLOGY RESEARCH INSTITUTE, Hsinchu (TW)

(72) Inventors: Chang-Jung CHANG, Taoyuan City (TW); Albert WAN, Hsinchu City (TW); Min-Yan DONG, Fuxing Township (TW); Jing-Wen TANG, Hsinchu City (TW)

(73) Assignee: INDUSTRIAL TECHNOLOGY RESEARCH INSTITUTE, Hsinchu (TW)

(21) Appl. No.: 17/135,643

(22) Filed: Dec. 28, 2020

(51) Int. Cl. C08J 11/08

(52) U.S. Cl. CPC C08J 11/08; C08J 2367/00

(57) ABSTRACT

A method for decolorization of polyester fabrics is provided. The method for decolorization of polyester fabrics includes putting polyester fabrics into an extraction cell. The method for decolorization of polyester fabrics also includes making a supercritical fluid and a co-solvent flow into the extraction cell. The method for decolorization of polyester fabrics further includes adjusting the temperature in the extraction cell to be greater than or equal to the glass transition temperature of the polyester fabrics, so that the supercritical fluid and the co-solvent perform a decolorization reaction on the polyester fabrics. Moreover, the method for decolorization of polyester fabrics includes making the supercritical fluid and the co-solvent flow out of the extraction cell. The method for decolorization of polyester fabrics also includes taking the polyester fabrics out of the extraction cell.

### TECHNICAL FIELD

Embodiments of the present disclosure relate to a method for decolorization, and in particular they relate to a method for decolorization of polyester fabrics.

### BACKGROUND

With the increasing awareness of environmental protection, the reuse of industrial and civilian waste has become an important issue today. In recent years, the global annual output of polyester products has exceeded 70 million tons, of which the consumption of textiles accounts for more than 70% (about 50 million tons), while the consumption of PET bottles and other polyester accounts for less than 30%. However, only PET bottles and other polyesters have a complete recycling mechanism recently, while polyester fabrics used in textiles still face technical bottlenecks.

Generally, common methods used for decolorization of polyester fabrics include chemical oxidation-reduction (redox) decolorization. However, the dyes are not removed from the polyester fabrics in this method, and the residual dyes are likely to cause thermal decomposition reactions or other side reactions when the polyester fabrics are subsequently processed, resulting in reduced purity and deterioration of the physical properties of the polyester fabrics.

Common methods used for decolorization of polyester fabrics also include using activated carbon and/or molecular sieve to adsorb/chelate for decolorization. However, the activated carbon used in this method and the polyester fabrics are not easily separated, so that the recycled polyester fabrics cannot achieve deep decolorization. In addition, the aforementioned process needs to be carried out at a high temperature, which also faces the point that the dyes are prone to cause thermal decomposition reactions or other side reactions.

Common methods used for decolorization of polyester fabrics further include organic solvent extraction decolorization. However, using this method to achieve a high decolorization yield requires a higher concentration or a large amount of organic solvents, and the waste liquid treatment after the polyester fabrics decolorization may cause other environmental protection issues.

### SUMMARY

A method for decolorizing polyester fabrics is provided in the embodiments of the present disclosure, which uses supercritical fluid (e.g., carbon dioxide (CO₂)) to cause the molecular chains of dyed polyester fabrics to swell, so that the dyes in the polyester fabrics are dispersed, and uses a co-solvent to extract and dissolve the dispersed dyes to achieve deep decolorization of the molecular chains of polyester fabric. This method may effectively increase the decolorization yield of polyester fabrics without expending a large amount of cost, and the subsequent processes are simpler and do not cause additional environmental protection issues.

The embodiments of the present disclosure include a method for decolorization of polyester fabrics. The method for decolorization of polyester fabrics includes putting polyester fabrics into an extraction cell. The method for decolorization of polyester fabrics also includes making a supercritical fluid and a co-solvent flow into the extraction cell. The method for decolorization of polyester fabrics further includes adjusting the temperature in the extraction cell to be greater than or equal to the glass transition temperature of the polyester fabrics, so that the supercritical fluid and the co-solvent perform a decolorization reaction on the polyester fabrics. Moreover, the method for decolorization of polyester fabrics includes making the supercritical fluid and the co-solvent flow out of the extraction cell. The method for decolorization of polyester fabrics also includes taking the polyester fabrics out of the extraction cell.

### BRIEF DESCRIPTION OF THE DRAWINGS

Aspects of the embodiments of the present disclosure can be understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 illustrates a schematic diagram of the recycled (dyed) textile after being treated with supercritical carbon dioxide.

FIG. 2 illustrates a method for decolorization of polyester fabrics according to one embodiment of the present disclosure.

FIG. 3 is a schematic diagram illustrating a decolorization device according to one embodiment of the present disclosure.

FIG. 4A is a color strength (K/S)-wavelength (nm) diagram at different temperatures of the extraction cell.

FIG. 4B is a decolorization yield (%)-temperature (° C.) diagram.

FIG. 5A is a color strength (K/S)-wavelength (nm) diagram at different pressures of the extraction cell.

FIG. 5B is a decolorization yield (%)-pressure (MPa) diagram.

FIG. 6 is a color strength (K/S)-wavelength (nm) diagram of Embodiment 1 to Embodiment 3 and Comparative example 1.

FIG. 7 is a color strength (K/S)-wavelength (nm) diagram of Embodiment 3 to Embodiment 5.

### DETAILED DESCRIPTION

The following disclosure provides many different embodiments, or examples, for implementing different features of the subject matter provided. It should be understood that additional operations can be provided before, during, and after the method, and some of the operations described can be replaced or eliminated for other embodiments of the method.

In the present disclosure, the terms “about,” “approximately” and “substantially” typically mean +/−20% of the stated value, more typically +/−10% of the stated value, more typically +/−5% of the stated value, more typically +/−3% of the stated value, more typically +/−2% of the stated value, more typically +/−1% of the stated value and even more typically +1-0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood through one of ordinary skill in the art to which this disclosure belongs. It should be understood that terms such as those defined in commonly used dictionaries should be interpreted as having a meaning that is consistent with their meaning in the context of the relevant art and will not be interpreted in an idealized or overly formal sense unless expressly so defined in the embodiments of the present disclosure.

In the embodiment of the present disclosure, the recycled (dyed) polyester fabrics are put into an extraction cell, the supercritical fluid (e.g., supercritical carbon dioxide (CO₂)) is introduced to cause the molecular chains of polyester fabrics to swell, and the co-solvent (e.g., ethanol) is also used to extract the dispersed dyes, thereby effectively increasing the decolorization yield of polyester fabrics without expending a large amount of cost, and improving the reusability of the recycled polyester.

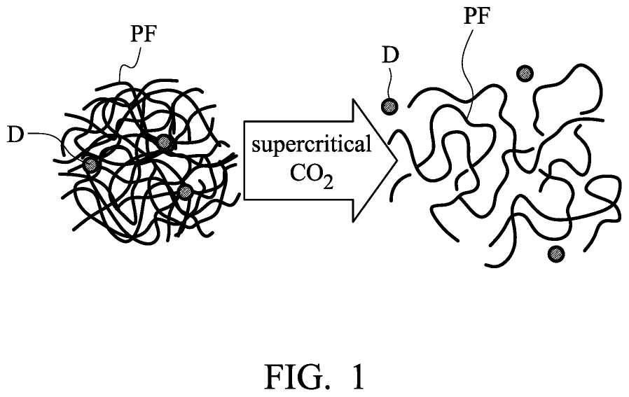

FIG. 1 illustrates a schematic diagram of the recycled (dyed) textile after being treated with supercritical carbon dioxide (CO₂). As shown in FIG. 1, the recycled (dyed) textile contains a plurality of polyester fabrics PF, and the dye molecules D are distributed in the high-density molecular chains of polyester fabrics PF. These high-density molecular chains of polyester fabrics PF are treated with supercritical carbon dioxide to produce swelling, which makes the polyester fabrics PF and dye molecules D dispersed (density reduction). After introducing a co-solvent (e.g., ethanol), the co-solvent may more easily dissolve the dye molecules D from the molecular chains of polyester fabrics PF.

In some embodiments, the co-solvent may include water (e.g., when the temperature in the extraction cell is greater than 100° C.), carbon dioxide, alkanes, ketones, alcohols, or any other common solvent, but the present disclosure is not limited thereto. In some embodiments, the co-solvent may be a polar solvent. Since general dye molecules are usually polar molecules, when the co-solvent is a polar solvent, the efficiency of dissolving the dye molecules from the molecular chains of polyester fabrics PF may be further increased.

In addition to the aforementioned ingredients, in some embodiments, the co-solvent may further include an additive. The additive may include sodium sulphoxylate formaldehyde, sodium dithionite, thiourea dioxide, sodium hydroxide, or any other applicable reagent, but the present disclosure is not limited thereto. These reagents may decompose the dye molecules, thereby further improving the decolorization yield of polyester fabrics.

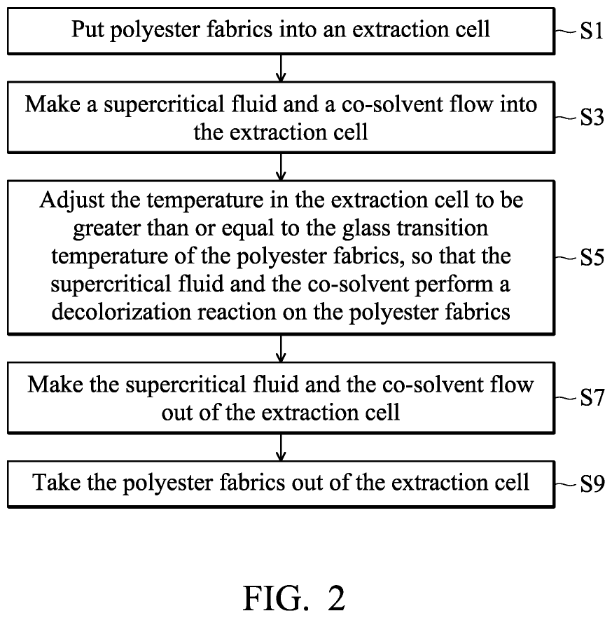

FIG. 2 illustrates a method for decolorization of polyester fabrics according to one embodiment of the present disclosure. Referring to FIG. 2, in step S1, the method for decolorization of polyester fabrics includes putting polyester fabrics into an extraction cell; in step S3, the method for decolorization of polyester fabrics also includes making a supercritical fluid and a co-solvent flow into the extraction cell; in step S5, the method for decolorization of polyester fabrics further includes adjusting the temperature in the extraction cell to be greater than or equal to the glass transition temperature (Tg) of the polyester fabrics, so that the supercritical fluid and the co-solvent perform a decolorization reaction on the polyester fabrics. Moreover, in step S7, the method for decolorization of polyester fabrics includes making the supercritical fluid and the co-solvent flow out of the extraction cell; in step S9, the method for decolorization of polyester fabrics also includes taking the polyester fabrics out of the extraction cell.

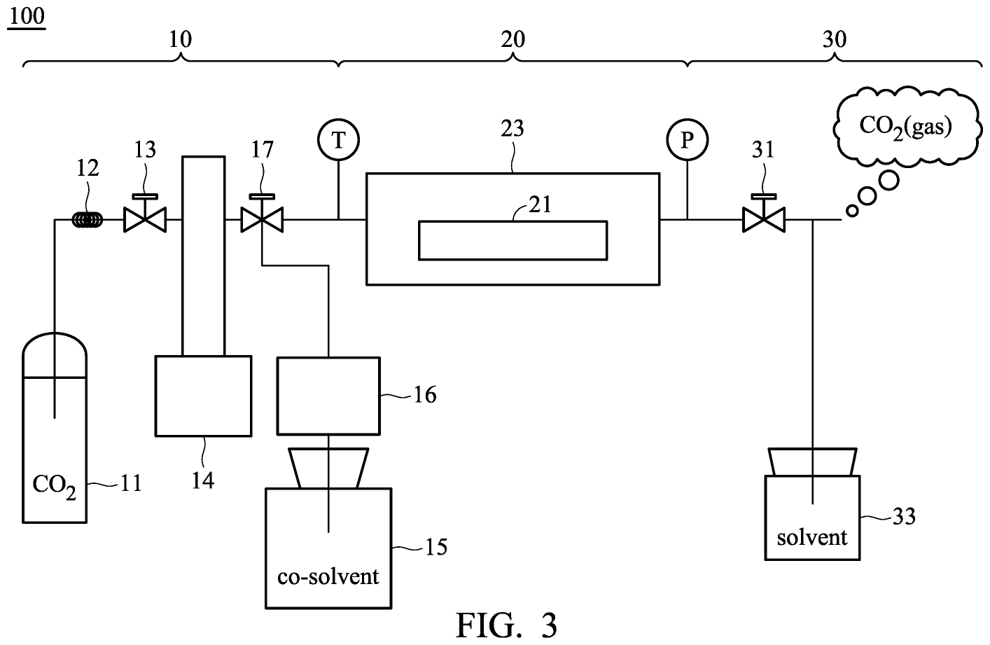

FIG. 3 is a schematic diagram illustrating a decolorization device 100 according to one embodiment of the present disclosure. It should be noted that some components of the decolorization device 100 may be omitted in FIG. 3 for the sake of brevity.

Referring to FIG. 3, the decolorization device 100 may include a feed system 10, an equilibrium system 20, and a separation system 30. In this embodiment, the (supercritical) fluid is carbon dioxide (CO₂) as an example, but the present disclosure is not limited thereto. The carbon dioxide and the co-solvent may enter the equilibrium system 20 (extraction cell 21) through the feed system 10 at a fixed pressure or flow rate. After the dyes of the cloth (textile) are dissolved, the fluid may be discharged and collected by the separation system 30.

As shown in FIG. 3, in the feed system 10, the carbon dioxide contained in the gas cylinder 11 may be converged to pass through a cooler 12 (e.g., a cooling coil) 12, so that the carbon dioxide may maintain the liquid state to facilitate pressurization. The cooled carbon dioxide may be fed into a syringe high-pressure pump (e.g., syringe pump 14 shown in FIG. 3) via the 3-way diverter valve 13, and the syringe pump 14 may adjust the flow rate or pressure to control the fluid status.

Co-solvent contained in the container 15 may be fed into the high-performance liquid chromatography (HPLC) pump 16. The pressurized carbon dioxide fluid flows out of the syringe pump 14 and is guided with the co-solvent into the extraction cell 21 of the equilibrium system 20 via the 3-way diverter valve 17.

As shown in FIG. 3, in the equilibrium system 20, the extraction cell 21 may be a 100 mL high-pressure resistant stainless steel tube, and the two ends of the extraction cell 21 may be connected to the pipe fittings in the system by two reducing joints. The extraction cell 21 is located in the temperature-controlled oven 23, and the temperature in the extraction cell 21 may be controlled by the oven 23.

As shown in FIG. 3, in the separation system 30, the gas-phase fluid (e.g., carbon dioxide and co-solvent gas) flows out through the back pressure valve 31 and then is discharged, and may be collected by the solvent in the container 33. In some embodiments, the container 33 is filled with a solvent capable of dissolving dyes (e.g., acetone capable of dissolving azo dyes), but the present disclosure is not limited thereto. In some other embodiments, the discharged gas-phase fluid flows out through the back pressure valve 31 and may be filtered through a filter material (e.g., activated carbon) to remove the dyes, and then returned to the 3-way diverter valve 17 for reuse.

In some embodiments, the equilibrium state during extraction in the extraction cell 21 may be divided into static equilibrium and dynamic equilibrium. The difference lies in whether the fluid is flowing and discharged from the end of the equilibrium system 20. In the static equilibrium, the normal pressure state is maintained in the extraction cell 21, and the pressure of the back pressure valve 31 is controlled to be higher than the pressure in the extraction cell 21, so that the fluid cannot be discharged; the dynamic equilibrium is to feed the fluid into the extraction cell 21 at a fixed flow rate by the syringe pump 14 and discharge the fluid from the back pressure valve 31, and at this time, the pressure of the back pressure valve 31 is lower than the pressure in the feed system 10 and the extraction cell 21.

In some embodiments, during the decolorization reaction, the temperature in the extraction cell 21 may be between about 80° C. and about 300° C., and/or the pressure in the extraction cell 21 may be between about 15 MPa and about 30 MPa, but the present disclosure is not limited thereto.

In the following, the temperature and pressure in the extraction cell 21 in some embodiments of the present disclosure and comparative examples during the decolorization reaction of polyester fabrics will be determined by the temperature control process and the pressure control process.

### Temperature Control Process

Step 1: The polyester fabrics dyed with an azo dye (e.g., dyed textiles) were cut into a size of 5×5 cm². Next, the dyed polyester fabrics were put into a 100 mL extraction cell 21, and the extraction cell 21 was set in an oven 23.

Step 2: After the pressure of the extraction cell 21 reached the set 20 MPa, dynamic equilibrium was performed. The syringe pump 14 was used to feed the high-pressure supercritical carbon dioxide at a fixed flow rate of 7 mL/min into the extraction cell 21 first, and then the supercritical carbon dioxide left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide was fed at a fixed flow rate of 7 mL/min into the extraction cell 21, and then the supercritical carbon dioxide left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process. That is, the complete decolorization process may include two static equilibriums and two dynamic equilibriums, but the present disclosure is not limited thereto.

In the aforementioned Step 2, the temperature of the extraction cell 21 was set to 40° C., 60° C., 80° C., 100° C., and 120° C., and the complete decolorization processes were performed at the aforementioned temperatures respectively, and the results were compared graphically.

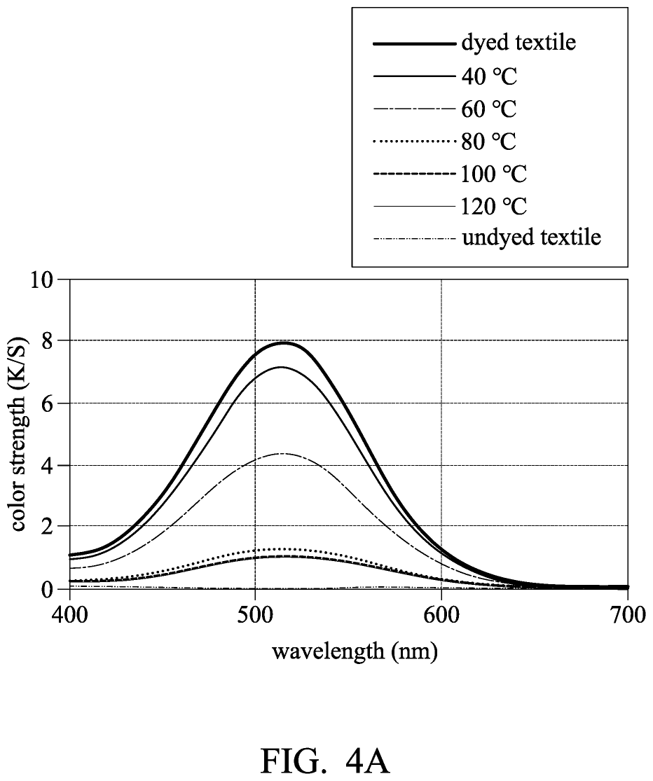

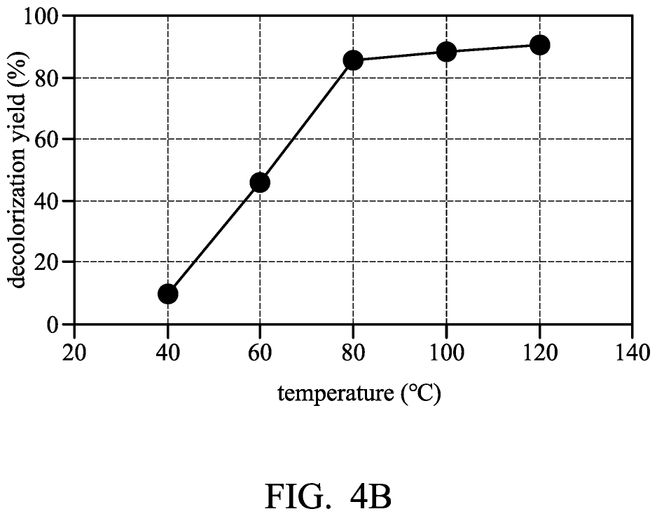

FIG. 4A is a color strength (K/S)-wavelength (nm) diagram at different temperatures of the extraction cell 21. FIG. 4B is a decolorization yield (%)-temperature (° C.) diagram.

Referring to FIG. 4A, as the temperature of the extraction cell 21 is higher, the color strength of the decolorized textile (polyester fabrics) is closer to that of the undyed textile. When the temperature of the extraction tank 21 is greater than or equal to the glass transition temperature (Tg, about 80° C.) of the polyester fabrics, the dispersed dyes may be effectively extracted from the rubbery polyester chain, which significantly increases the decolorization yield. However, when the temperature is greater than or equal to the glass transition temperature of the polyester fabric (i.e., 80° C., 100° C., and 120° C.), the color strength difference between each other is not significant.

Referring to FIG. 4B, as the temperature of the extraction cell 21 is higher, the decolorization yield is also higher. However, when the temperature is greater than or equal to the glass transition temperature (Tg, about 80° C.) of the polyester fabric, the decolorization yield difference between each other is not significant.

### Pressure Control Process

Step 1: The polyester fabrics dyed with an azo dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature of the extraction cell 21 reached the set 120° C., dynamic equilibrium was performed. The syringe pump 14 was used to feed the high-pressure supercritical carbon dioxide at a fixed flow rate of 7 mL/min into the extraction cell 21 first, and then the supercritical carbon dioxide left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide was fed at a fixed flow rate of 7 mL/min into the extraction cell 21, and then the supercritical carbon dioxide left the equilibrium system 20 for 20 minutes to discharge the extracted fluid to the separation system 30, and the polyester fabrics and the extraction cell 21 were cleaned at the same time.

Finally, repeat Step 3 and Step 4 were repeated, and the decolorized polyester fabrics were taken out of the extraction cell 21 to complete the decolorization process. That is, the complete decolorization process may include two static equilibriums and two dynamic equilibriums, but the present disclosure is not limited thereto.

In the aforementioned Step 2, the pressure of the extraction cell 21 was set to 15 MPa, 20 MPa, 25 MPa, and 30 MPa, and the complete decolorization processes were performed at the aforementioned pressures respectively, and the results were compared graphically.

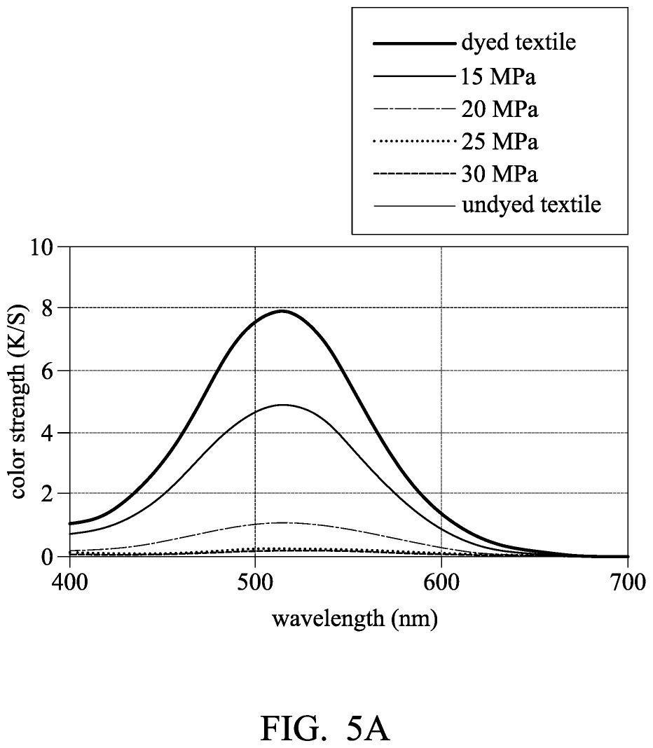

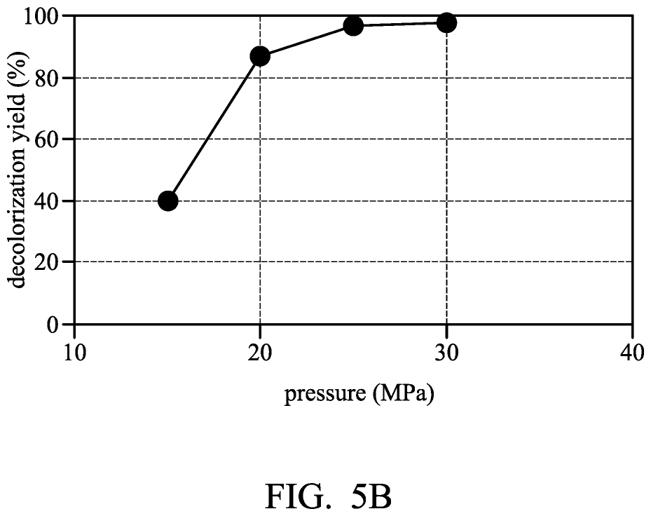

FIG. 5A is a color strength (K/S)-wavelength (nm) diagram at different pressures of the extraction cell 21. FIG. 5B is a decolorization yield (%)-pressure (MPa) diagram.

Referring to FIG. 5A, as the pressure of the extraction cell 21 is higher, the color strength of the decolorized textile (polyester fabrics) is closer to that of the undyed textile. However, when the pressure is greater than or equal to 20 MPa, the color strength difference between each other is not significant.

Referring to FIG. 5B, when the pressure of the extraction cell 21 is increased from 15 MPa to 30 MPa, the density of supercritical CO₂ is increased from 280 kg/m³ to 585 kg/m³, resulting in an increase of the solubility of the fluid and an increase of the decolorization yield. That is, as the pressure of the extraction cell 21 is higher, the decolorization yield is also higher. However, when the pressure is greater than or equal to 20 MPa (i.e., 20 MPa, 25 MPa, and 30 MPa), the decolorization yield difference between each other is not significant.

Based on the results of the aforementioned temperature control process and pressure control process, the following embodiments were performed with the temperature of the extraction cell 21 being set to 80° C. and the pressure of the extraction cell 21 being set to 20 MPa.

### Embodiment 1

Step 1: The polyester fabrics dyed with an azo dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature and the pressure of the extraction cell 21 reached the set temperature and pressure (80° C. and 20 MPa), dynamic equilibrium was performed. The syringe pump 14 was used to feed the high-pressure supercritical carbon dioxide at a fixed flow rate of 9 mL/min and the HPLC pump 16 was used to feed n-hexane at a fixed flow rate of 1 mL/min into the extraction cell 21 at the same time, and then the supercritical carbon dioxide and n-hexane left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide and n-hexane were fed respectively at a fixed flow rate of 9 mL/min and a fixed flow rate of 1 mL/min into the extraction cell 21, and then the supercritical carbon dioxide and n-hexane left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process.

### Embodiment 2

Step 1: The polyester fabrics dyed with an azo dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature and the pressure of the extraction cell 21 reached the set temperature and pressure (80° C. and 20 MPa), dynamic equilibrium was performed. The syringe pump 14 was used to feed the high-pressure supercritical carbon dioxide at a fixed flow rate of 9 mL/min and the HPLC pump 16 was used to feed acetone at a fixed flow rate of 1 mL/min into the extraction cell 21 at the same time, and then the supercritical carbon dioxide and acetone left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide and acetone were fed respectively at a fixed flow rate of 9 mL/min and a fixed flow rate of 1 mL/min into the extraction cell 21, and then the supercritical carbon dioxide and acetone left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process.

### Embodiment 3

Step 1: The polyester fabrics dyed with an azo dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature and the pressure of the extraction cell 21 reached the set temperature and pressure (80° C. and 20 MPa), dynamic equilibrium was performed. The syringe pump 14 was used to feed the high-pressure supercritical carbon dioxide at a fixed flow rate of 9 mL/min and the HPLC pump 16 was used to feed ethanol at a fixed flow rate of 1 mL/min into the extraction cell 21 at the same time, and then the supercritical carbon dioxide and ethanol left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide and ethanol were fed respectively at a fixed flow rate of 9 mL/min and a fixed flow rate of 1 mL/min into the extraction cell 21, and then the supercritical carbon dioxide and ethanol left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process.

### Comparative Example 1

Step 1: The polyester fabrics dyed with an azo dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature and the pressure of the extraction cell 21 reached the set temperature and pressure (80° C. and 20 MPa), dynamic equilibrium was performed. The syringe pump 14 was used to feed the high-pressure supercritical carbon dioxide at a fixed flow rate of 10 mL/min into the extraction cell 21, and then make the supercritical carbon dioxide left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide was fed at a fixed flow rate of 10 mL/min into the extraction cell 21, and then the supercritical carbon dioxide left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process.

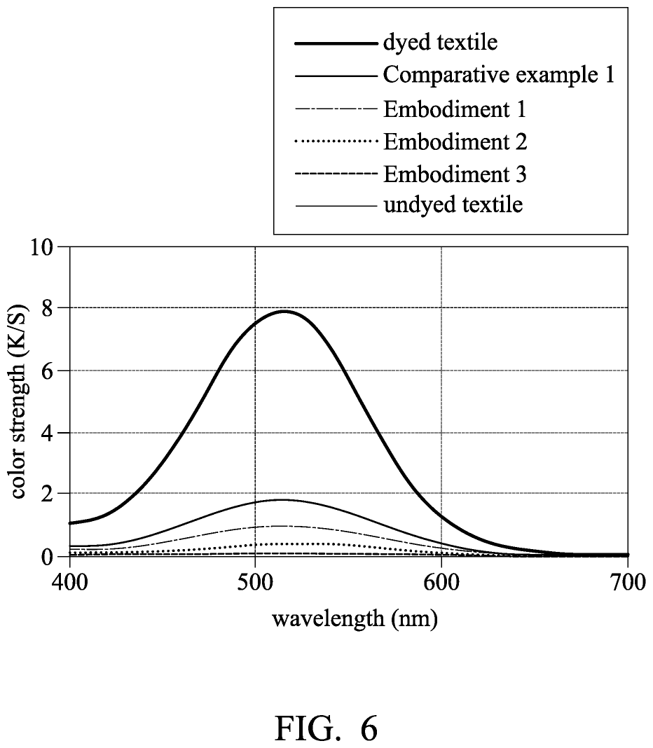

FIG. 6 is a color strength (K/S)-wavelength (nm) diagram of Embodiment 1 to Embodiment 3 and Comparative example 1. Meanwhile, the decolorization yields of Embodiment 1 to Embodiment 3 and Comparative example 1 are summarized in Table 1.

TABLE 1

| | co-solvent | decolorization yield |
|---|---|---|
| Embodiment 1 | 10 vol % n-hexane | 88% |
| Embodiment 2 | 10 vol % acetone | 95% |
| Embodiment 3 | 10 vol % ethanol | 99% |
| Comparative example 1 | none | 78% |

Referring to Table 1 and FIG. 6, compared with Comparative example 1 (only supercritical CO₂ is used and no co-solvent is added), the yields of Embodiment 1, Embodiment 2, and Embodiment 3 are significantly improved. That is, by using a co-solvent and the supercritical CO₂ for decolorization, the decolorization effect may be effectively improved.

Moreover, when using 10 vol % ethanol as a co-solvent and the supercritical CO₂ (i.e., Embodiment 3) for decolorization, the extraction cell 21 only needs to reach a temperature of 80° C. and a pressure of 20 MPa to achieve 99% decolorization yield. In contrast, when only the supercritical CO₂ is used for decolorization (without co-solvent added) (i.e., Comparative example 1), the extraction cell 21 needs to reach a temperature of 120° C. and a pressure of 30 MPa to achieve 99% decolorization yield.

The following are different embodiments in which water and/or ethanol were used as co-solvents and the temperature of the extraction cell 21 was set to 80° C. and the pressure of the extraction cell 21 was set to 20 MPa for decolorization.

### Embodiment 4

Step 1: The polyester fabrics dyed with an azo dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature and the pressure of the extraction cell 21 reached the set temperature and pressure (80° C. and 20 MPa), dynamic equilibrium was performed. The syringe pump 14 was used to feed the high-pressure supercritical carbon dioxide at a fixed flow rate of 9 mL/min and the HPLC pump 16 was used to feed deionized water (H₂O) at a fixed flow rate of 1 mL/min into the extraction cell 21 at the same time, and then the supercritical carbon dioxide and ethanol left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide and deionized water were fed respectively at a fixed flow rate of 9 mL/min and a fixed flow rate of 1 mL/min into the extraction cell 21, and then the supercritical carbon dioxide and deionized water left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process.

### Embodiment 5

Step 1: The polyester fabrics dyed with an azo dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature and the pressure of the extraction cell 21 reached the set temperature and pressure (80° C. and 20 MPa), dynamic equilibrium was performed. The syringe pump 14 was used to feed the high-pressure supercritical carbon dioxide at a fixed flow rate of 9 mL/min and the HPLC pump 16 was used to feed a mixture of deionized water (H₂O) and ethanol with a volume ratio of 1:1 at a fixed flow rate of 1 mL/min into the extraction cell 21 at the same time, and then the supercritical carbon dioxide and the mixture of deionized water and ethanol left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide and a mixture of deionized water and ethanol with a volume ratio of 1:1 were fed respectively at a fixed flow rate of 9 mL/min and a fixed flow rate of 1 mL/min into the extraction cell 21, and then the supercritical carbon dioxide and the mixture of deionized water and ethanol left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process.

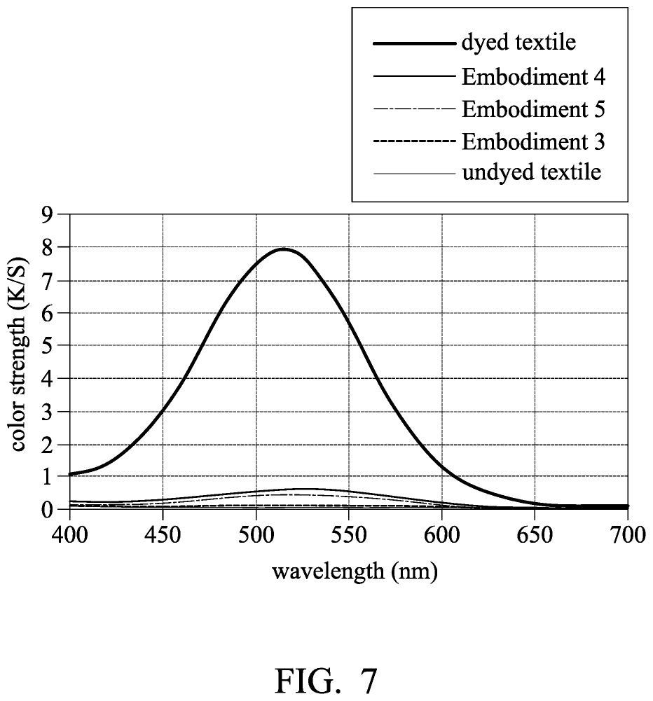

FIG. 7 is a color strength (K/S)-wavelength (nm) diagram of Embodiment 3 to Embodiment 5. Meanwhile, the decolorization yields of Embodiment 3 to Embodiment 5 are summarized in Table 2.

TABLE 2

| | co-solvent | decolorization yield |
|---|---|---|
| Embodiment 4 | 10 vol % H₂O | 92% |
| Embodiment 5 | 5 vol % H₂O and | 95% |
| | 5 vol % ethanol | |
| Embodiment 3 | 10 vol % ethanol | 99% |

Referring to Table 2 and FIG. 7, both Embodiment 4 (10 vol % H₂O used as a co-solvent and the supercritical CO₂ for decolorization) and Embodiment 5 (5 vol % H₂O and 5 vol % ethanol used as a co-solvent and the supercritical CO₂ for decolorization) have good decolorization yields. However, the decolorization yields of Embodiment 4 and Embodiment 5 are slightly inferior to the decolorization yield of Embodiment 3 (10 vol % ethanol used as a co-solvent and the supercritical CO₂ for decolorization).

The following are different embodiments in which water and/or ethanol were used as co-solvents and the temperature of the extraction cell 21 was set to 120° C. and the pressure of the extraction cell 21 was set to 30 MPa for decolorization. In some embodiments (e.g., Embodiment 7), the co-solvent further included an additive.

### Embodiment 6

Step 1: The polyester fabrics dyed with an anthracene dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature and the pressure of the extraction cell 21 reached the set temperature and pressure (120° C. and 30 MPa), dynamic equilibrium was performed. The syringe pump 14 was used to feed the high-pressure supercritical carbon dioxide at a fixed flow rate of 9 mL/min and the HPLC pump 16 was used to feed a mixture of deionized water (H₂O) and ethanol with a volume ratio of 1:1 at a fixed flow rate of 1 mL/min into the extraction cell 21 at the same time, and then the supercritical carbon dioxide and the mixture of deionized water and ethanol left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide and a mixture of deionized water and ethanol with a volume ratio of 1:1 were fed respectively at a fixed flow rate of 9 mL/min and a fixed flow rate of 1 mL/min into the extraction cell 21, and then the supercritical carbon dioxide and the mixture of deionized water and ethanol left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process.

### Embodiment 7

Step 1: The polyester fabrics dyed with an anthracene dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature and the pressure of the extraction cell 21 reached the set temperature and pressure (120° C. and 30 MPa), dynamic equilibrium was performed. The syringe pump 14 was used to feed the high-pressure supercritical carbon dioxide at a fixed flow rate of 9 mL/min and the HPLC pump 16 was used to feed a mixture of deionized water (H₂O) and ethanol with a volume ratio of 1:1 (which contains 0.3M thiourea dioxide and 1M sodium hydroxide (NaOH)) at a fixed flow rate of 1 mL/min into the extraction cell 21 at the same time, and then the supercritical carbon dioxide and the mixture of deionized water and ethanol left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide and a mixture of deionized water and ethanol with a volume ratio of 1:1 (which contains 0.3M thiourea dioxide and 1M sodium hydroxide (NaOH)) were fed respectively at a fixed flow rate of 9 mL/min and a fixed flow rate of 1 mL/min into the extraction cell 21, and then the supercritical carbon dioxide and the mixture of deionized water and ethanol left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process.

### Comparative Example 2

Step 1: The polyester fabrics dyed with an anthracene dye (e.g., dyed textiles) were cut into a size of 5×5 cm². Next, the dyed polyester fabrics were put into a 100 mL extraction cell 21, and the extraction cell 21 was set in an oven 23.

Step 2: After the temperature and the pressure of the extraction cell 21 reached the set temperature and pressure (120° C. and 30 MPa), dynamic equilibrium was performed. The syringe pump 14 was used to feed the high-pressure supercritical carbon dioxide at a fixed flow rate of 10 mL/min into the extraction cell 21, and then the supercritical carbon dioxide left the equilibrium system 20 for 20 minutes.

Step 3: The extraction cell 21 was switched to normal pressure mode to perform static equilibrium for 30 minutes.

Step 4: After the static equilibrium was over, the supercritical carbon dioxide was fed at a fixed flow rate of 10 mL/min into the extraction cell 21, and then the supercritical carbon dioxide left the equilibrium system 20 for 20 minutes to discharge the extracted fluid to the separation system 30, and the polyester fabrics and the extraction cell 21 were cleaned at the same time.

Finally, Step 3 and Step 4 were repeated, and the decolorized polyester fabrics were taken out of the extraction cell 21 to complete the decolorization process.

The decolorization yields of Embodiment 6, Embodiment 7 and Comparative example 2 are summarized in Table 3.

TABLE 3

| | co-solvent | decolorization yield |
|---|---|---|
| Embodiment 6 | 5 vol % H₂O and | 81% |
| | 5 vol % ethanol | |
| Embodiment 7 | 0.3M thiourea dioxide | 91% |
| | and 1M sodium | |
| | hydroxide dissolved | |
| | in 5 vol % H₂O | |
| | and 5 vol % ethanol | |
| Comparative example 2 | none | 76% |

Accordingly, compared with common methods used for decolorization of polyester fabrics that have a poor decolorization yield (less than 80%), or a large amount of cost is required and/or additional environmental protection issues are generated in order to achieve a better decolorization yield, by the method for decolorization of polyester fabrics in the embodiments of the present disclosure, the decolorization yield of polyester fabrics may be effectively improved without expending a large amount of cost and causing additional environmental protection issues, thereby improving the reusability of the recycled polyester.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. Therefore, the scope of protection should be determined through the claims. In addition, although some embodiments of the present disclosure are disclosed above, they are not intended to limit the scope of the present disclosure.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

What is claimed is:

1. A method for decolorization of polyester fabrics, comprising:
putting polyester fabrics into an extraction cell;
making a supercritical fluid and a co-solvent flow into the extraction cell;
adjusting a temperature in the extraction cell to be greater than or equal to a glass transition temperature of the polyester fabrics, so that the supercritical fluid and the co-solvent perform a decolorization reaction on the polyester fabrics;
making the supercritical fluid and the co-solvent flow out of the extraction cell; and
taking the polyester fabrics out of the extraction cell.

2. The method for decolorization of polyester fabrics as claimed in claim 1, wherein the supercritical fluid is supercritical carbon dioxide.

3. The method for decolorization of polyester fabrics as claimed in claim 1, wherein during the decolorization reaction, a pressure in the extraction cell is between 15 MPa and 30 MPa.

4. The method for decolorization of polyester fabrics as claimed in claim 1, wherein during the decolorization reaction, the temperature in the extraction cell is between 80° C. and 300° C., and a pressure in the extraction cell is between 15 MPa and 30 MPa.

5. The method for decolorization of polyester fabrics as claimed in claim 1, wherein during the decolorization reaction, the temperature in the extraction cell is between 80° C. and 120° C., and a pressure in the extraction cell is between 15 MPa and 30 MPa.

6. The method for decolorization of polyester fabrics as claimed in claim 1, wherein the co-solvent comprises water, alkanes, ketones, alcohols, or a mixture thereof.

7. The method for decolorization of polyester fabrics as claimed in claim 1, wherein the co-solvent further comprises an additive, and the additive includes sodium sulphoxylate formaldehyde, sodium dithionite, thiourea dioxide, or sodium hydroxide.

8. The method for decolorization of polyester fabrics as claimed in claim 1, wherein the co-solvent is a polar solvent.
